(19) United States
(12) Patent Application Publication
(10) Pub. No.: US 2023/0070037 A1
(43) Pub. Date: Mar. 9, 2023

(54) METHOD FOR PROCESSING AUDIO SIGNAL AND ELECTRONIC DEVICE

(71) Applicant: BEIJING DAJIA INTERNET INFORMATION TECHNOLOGY CO., LTD., Beijing (CN)

(72) Inventors: Xinyue FAN, Beijing (CN); Chen ZHANG, Beijing (CN); Xiguang ZHENG, Beijing (CN)

(21) Appl. No.: 17/898,922

(22) Filed: Aug. 30, 2022

(30) Foreign Application Priority Data
Aug. 31, 2021 (CN) 202111014196.6

(51) Int. Cl. H04S 7/00; G10H 1/00; H04S 5/00

(52) U.S. Cl. CPC H04S 7/302; G10H 1/0008; H04S 5/005; G10H 2210/076; H04S 2400/11; H04S 2420/01

(57) ABSTRACT

A method for processing an audio signal and an electronic device, relate to the field of audio and video technology. The method includes: detecting beat information of the audio signal; and obtaining virtual surround sound for the audio signal by performing a convolution operation on a head-related transfer function and the audio signal based on the beat information of the audio signal.

### CROSS REFERENCE

This application is based upon and claims priority to Chinese Patent Application No. 202111014196.6, filed on Aug. 31, 2021, the entire content of which is incorporated herein by reference.

### TECHNICAL FIELD

The present disclosure relates to the field of audio and video technology, and in particular, to a method for processing an audio signal and an electronic device.

### BACKGROUND

In the related art, virtual surround sound is able to process multi-channel signals and use two or three speakers to simulate the experience of real physical surround sound, so that an audience can feel that the sound comes from different directions. This kind of system is popular among consumers who wish to enjoy the surround sound experience without the need for a large number of speakers. The virtual surround sound technology makes full use of binaural effect, frequency filtering effect of a human ear, and a head-related transfer function (HRTF), to artificially change a sound source localization, so that a corresponding sound image is produced in the human brain in corresponding spatial direction. A sound field of virtual surround sound is often used in 3D sound effects in a game, such as to calculate the effect of multiple sound sources (footsteps, distant animals, etc.) interacting (reflection, obstruction) with the environment in a game scene. In music, virtual surround sound is usually used as a special sound effect to enhance fun and beauty of the music.

### SUMMARY

Exemplary embodiments of the present disclosure provide a method for processing an audio signal and an apparatus for processing an audio signal.

According to exemplary embodiments of the present disclosure, a method for processing an audio signal is provided, which includes: detecting beat information of the audio signal; and obtaining virtual surround sound for the audio signal by performing a convolution operation on a head-related transfer function and the audio signal based on the beat information of the audio signal.

In some embodiments, a step of detecting beat information of the audio signal includes: converting the audio signal into a mono audio signal; and detecting the beat information of the mono audio signal as the beat information of the audio signal.

In some embodiments, a step of detecting the beat information of the mono audio signal as the beat information of the audio signal includes: detecting spectral flux of the mono audio signal; and detecting the beat information of the mono audio signal based on the spectral flux.

In some embodiments, a step of detecting the beat information of the mono audio signal as the beat information of the audio signal includes: extracting a frequency domain feature of the mono audio signal; predicting, for each frame of the audio signal, probability of a frame of the audio signal being a beat point based on the frequency domain feature; and determining the beat information of the audio signal based on the probability.

In some embodiments, a step of performing a convolution operation on a head-related transfer function and the audio signal based on the beat information of the audio signal includes: determining, based on the beat information of the audio signal, a head-related frequency impulse response of the audio signal from the head-related transfer function; and performing the convolution operation on the head-related frequency impulse response of the audio signal and each frame of the audio signal.

In some embodiments, a step of performing a convolution operation on a head-related transfer function and the audio signal based on the beat information of the audio signal includes: determining, based on the beat information of the audio signal, a first head-related frequency impulse response corresponding to at least one frame of the audio signal from the head-related transfer function; determining, based on the beat information of the audio signal, a second head-related frequency impulse response corresponding to each frame of the audio signal except the at least one frame from the head-related transfer function; performing the convolution operation on the first head-related frequency impulse response and the at least one frame of the audio signal; and performing the convolution operation on the second head-related frequency impulse response and each frame of the audio signal except the at least one frame.

In some embodiments, a step of performing a convolution operation on a head-related transfer function and the audio signal based on the beat information of the audio signal includes: obtaining a head-related frequency impulse response of the head-related transfer function in continuous directions; determining a rotation angle of each frame of the audio signal based on the beat information of the audio signal; determining the head-related frequency impulse response corresponding to each frame of the audio signal based on the rotation angle of each frame of the audio signal; and performing the convolution operation on corresponding head-related frequency impulse response and corresponding frame of the audio signal.

In some embodiments, a step of determining a rotation angle of each frame of the audio signal based on the beat information of the audio signal includes: calculating duration of each beat of the audio signal based on the beat information of the audio signal; calculating time for one rotation of the audio signal based on the duration of each beat of the audio signal; and calculating the rotation angle of each frame of the audio signal based on duration of each frame of the audio signal and the time for one rotation of the audio signal; wherein the time for one rotation of the audio signal is a predetermined integer multiple of the duration of each beat of the audio signal.

In some embodiments, a step of detecting beat information of the audio signal includes: detecting downbeat information of the audio signal.

In some embodiments, after a step of detecting the beat information of the audio signal, the method for processing the audio signal further includes: determining an initial azimuth angle of the audio signal based on the downbeat information.

In some embodiments, the method for processing the audio signal further includes: performing virtual surround sound processing on the audio signal through a predetermined audio effector.

In some embodiments, the predetermined audio effector includes a limiter.

According to exemplary embodiments of the present disclosure, an apparatus for processing an audio signal is provided, which includes: a beat detection unit configured to detect beat information of the audio signal; and an audio processing unit configured to obtain virtual surround sound for the audio signal by performing a convolution operation on a head-related transfer function and the audio signal based on the beat information of the audio signal.

In some embodiments, the beat detection unit is configured to: convert the audio signal into a mono audio signal; and detect the beat information of the mono audio signal as the beat information of the audio signal.

In some embodiments, the beat detection unit is configured to: detect spectral flux of the mono audio signal; and detect the beat information of the mono audio signal based on the spectral flux.

In some embodiments, the beat detection unit is configured to: extract a frequency domain feature of the mono audio signal; predict, for each frame of the audio signal, probability of a frame of the audio signal being a beat point based on the frequency domain feature; and determine the beat information of the audio signal based on the probability.

In some embodiments, the audio processing unit is configured to: determine, based on the beat information of the audio signal, a head-related frequency impulse response of the audio signal from the head-related transfer function; and perform the convolution operation on the head-related frequency impulse response of the audio signal and each frame of the audio signal.

In some embodiments, the audio processing unit is configured to: determine, based on the beat information of the audio signal, a first head-related frequency impulse response corresponding to at least one frame of the audio signal from the head-related transfer function; determine, based on the beat information of the audio signal, a second head-related frequency impulse response corresponding to each frame of the audio signal except the at least one frame from the head-related transfer function; perform the convolution operation on the first head-related frequency impulse response and the at least one frame of the audio signal; and perform the convolution operation on the second head-related frequency impulse response and each frame of the audio signal except the at least one frame.

In some embodiments, the audio processing unit is configured to: obtain a head-related frequency impulse response of the head-related transfer function in continuous directions; determine a rotation angle of each frame of the audio signal based on the beat information of the audio signal; determine the head-related frequency impulse response corresponding to each frame of the audio signal based on the rotation angle of each frame of the audio signal; and perform the convolution operation on corresponding head-related frequency impulse response and corresponding frame of the audio signal.

In some embodiments, the audio processing unit is configured to: calculate duration of each beat of the audio signal based on the beat information of the audio signal; calculate time for one rotation of the audio signal based on the duration of each beat of the audio signal; and calculate the rotation angle of each frame of the audio signal based on duration of each frame of the audio signal and the time for one rotation of the audio signal; wherein the time for one rotation of the audio signal is a predetermined integer multiple of the duration of each beat of the audio signal.

In some embodiments, the beat detection unit is configured to detect downbeat information of the audio signal.

In some embodiments, the apparatus for processing the audio signal further includes: an angle determination unit configured to determine an initial azimuth angle of the audio signal based on the downbeat information.

In some embodiments, the apparatus for processing the audio signal further includes: an effect processing unit configured to perform virtual surround sound processing on the audio signal through a predetermined audio effector.

In some embodiments, the predetermined audio effector includes a limiter.

According to exemplary embodiments of the present disclosure, an electronic device is provided, which includes: a processor; and a memory for storing processor-executable instructions, wherein the processor is configured to execute the instructions to implement the method for processing the audio signal according to exemplary embodiments of the present disclosure.

According to exemplary embodiments of the present disclosure, a computer-readable storage medium is provided, and the computer-readable storage medium has a computer program stored thereon, when executed by a processor of an electronic device, cause the electronic device to implement the method for processing the audio signal according to exemplary embodiments of the present disclosure.

According to exemplary embodiments of the present disclosure, a computer program product is provided, and the computer program product includes a computer program/instructions, which when executed by a processor, cause the method for processing the audio signal according to exemplary embodiments of the present disclosure to be implemented.

According to embodiments of the present disclosure, the dynamic feeling of the music can be enhanced, and the listening experience of the audience can be improved, so that the audience can feel sound immersive.

It should be understood that the foregoing general description and the following detailed description are exemplary and explanatory only and are not restrictive of the present disclosure.

### BRIEF DESCRIPTION OF THE DRAWINGS

The drawings, which are incorporated into and constitute a part of this specification, illustrate embodiments consistent with the present disclosure, and serve together with the specification, to explain the principles of the present disclosure and do not unduly limit the present disclosure.

FIG. 1 illustrates an exemplary system architecture 100 in which exemplary embodiments of the disclosure may be applied.

FIG. 2 illustrates a flowchart of a method for processing an audio signal according to an exemplary embodiment of the disclosure.

FIG. 3 illustrates a tempogram of a piece of music according to an exemplary embodiment of the disclosure.

FIG. 4 illustrates a generation process of virtual surround sound according to an exemplary embodiment of the disclosure.

FIG. 5 illustrates a block diagram of a system for generating virtual surround sound for music according to an exemplary embodiment of the disclosure.

FIG. 6 illustrates a block diagram of an apparatus for processing an audio signal according to an exemplary embodiment of the disclosure.

FIG. 7 illustrates a block diagram of an electronic device 700 according to an exemplary embodiment of the disclosure.

### DETAILED DESCRIPTION

In order to make those skilled in the art better understand technical solutions of the present disclosure, the technical solutions of the embodiments of the present disclosure will be clearly and completely described below with reference to the drawings.

It should be noted that terms “first”, “second” and the like in the specification and claims of the present disclosure and above drawings are used to distinguish similar objects, and are not necessarily used to describe a specific sequence or order. It should be understood that data used in this way may be interchanged where appropriate, so that embodiments of the present disclosure can be practiced in sequences other than those illustrated or described herein. Implementations described in following embodiments are not intended to represent all implementations consistent with the present disclosure. Instead, these implementations are merely examples of apparatus and methods consistent with some aspects of the present disclosure as recited in the appended claims.

It should be noted here that all expressions “at least one item of several items” in the present disclosure mean including three paratactic situations, namely “any item of the several items”, “a combination of any number of items of the several items”, and “all items of the several items”. For example, “including at least one of A and B” includes following three paratactic situations: (1) including A; (2) including B; (3) including A and B. For another example, “executing at least one of step 1 and step 2” means following three paratactic situations: (1) executing step 1; (2) executing step 2; (3) executing step 1 and step 2.

With the development of 3D audio technology, binaural recording technology, surround sound technology and Ambisonic technology have been fully utilized in various audio mixing and playback scenarios, and the public's demands for quality and effect of the audio have also increased. For example, the change of the sound travelling from a sound source to a wall and then to an ear can be simulated by using HRTF and reverberation. A simulation effect includes virtually placing the sound source anywhere in the three-dimensional space. Now 3D audio technology is also applied to games and music scenes, among which virtual surround sound technology is relatively widely used. The virtual surround sound technology can be used to relocate the sound source to create a feeling that the sound is surrounding the head. The present disclosure aims to control a speed of a change in the direction of the sound source using beat detection, so that the music can dance according to the beat of the music when playing at an earphone end, which is used as a special sound effect of the virtual surround sound for the music. The beat detection is used to control the change in the direction of the sound source, which will make the music more dynamic and will not destroy the rhythm of the music itself.

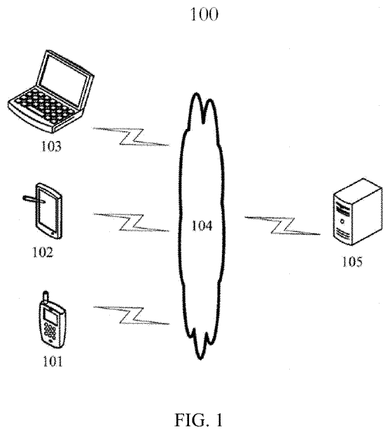

Hereinafter, a method for processing an audio signal and an apparatus for processing an audio signal according to exemplary embodiments of the present disclosure will be described in detail with reference to FIGS. 1 to 7.

FIG. 1 illustrates an exemplary system architecture 100 in which exemplary embodiments of the present disclosure may be applied.

As shown in FIG. 1, the system architecture 100 may include terminal devices 101, 102 and 103, a network 104 and a server 105. The network 104 is a medium used to provide communication links between the terminal devices 101, 102 and 103 and the server 105. The network 104 may include various connection types, such as wired, wireless communication links, or fiber optic cables, and the like. Users can use the terminal devices 101, 102 and 103 to interact with the server 105 via the network 104, to receive or send messages (e.g., audio signal processing requests, audio signals), and the like. Various audio playback applications may be installed on the terminal devices 101, 102 and 103. The terminal devices 101, 102 and 103 may be hardware or software. In a case where the terminal devices 101, 102 and 103 are hardware, they may be various electronic devices capable of audio playback, including but not limited to smart phones, tablet computers, laptop and desktop computers, earphones, and the like. In a case where the terminal devices 101, 102 and 103 are software, they can be installed in the electronic devices listed above, and they can be implemented as multiple software or software modules (e.g., to provide distributed services), or they can be implemented as single software or software modules, which is not specifically limited herein.

The server 105 may be a server that provides various services, for example, a background server that provides support for multimedia applications installed on the terminal devices 101, 102, and 103. The background server can parse and store received data such as upload requests for audio and video data, and can also receive audio signal processing requests sent by the terminal devices 101, 102, and 103, and feed back processed audio signals to the terminal devices 101, 102, 103.

It should be noted that the server may be hardware or software. In a case where the server is hardware, it can be implemented as a distributed server cluster composed of multiple servers, or it can be implemented as a single server. In a case where the server is software, it can be implemented as multiple software or software modules (e.g., to provide distributed services), or it can be implemented as single software or software module, which is not specifically limited herein.

It should be noted that the method for processing an audio signal provided by embodiments of the present disclosure is usually performed by a terminal device, but can also be performed by a server, or can be performed in cooperation by the terminal device and the server. Accordingly, the apparatus for processing an audio signal may be provided in the terminal device, in the server, or in both the terminal device and the server.

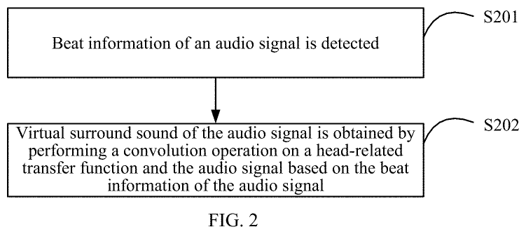

FIG. 2 illustrates a flowchart of a method for processing an audio signal according to an exemplary embodiment of the present disclosure. The audio signal processing here may be generation of virtual surround sound for an audio signal. According to embodiments of the present disclosure, the audio signal processing is described by taking the generation of virtual surround sound for the audio signal as an example.

Referring to FIG. 2, in step S201, beat information of an audio signal is detected. The audio signal here may be, for example, but not limited to, music. In embodiments of the present disclosure, music is taken as an example for description.

According to exemplary embodiments of the present disclosure, in a step where the beat information of the audio signal is detected, the audio signal may be first converted into a mono audio signal, and then the beat information of the mono audio signal is detected as the beat information of the audio signal. That is, in the present disclosure, when the music (e.g., stereo music) is not mono music, the music is first converted into mono music.

According to exemplary embodiments of the present disclosure, in a step where the beat information of the mono audio signal is detected as the beat information of the audio signal, spectral flux of the mono audio signal may be detected first, and then the beat information of the mono audio signal may be detected based on the spectral flux.

According to exemplary embodiments of the present disclosure, in a step where the beat information of the mono audio signal is detected as the beat information of the audio signal, a frequency domain feature of the mono audio signal may be extracted first, probability of a frame of the audio signal being a beat point is predicted, for each frame of the audio signal, based on the frequency domain feature, and then the beat information of the audio signal is determined based on the probability of a frame of the audio signal being a beat point.

As an example, in a step where the beat information of the audio signal is detected, beat detection can be performed through deep learning in one implementation. A related beat detection method based on deep learning is generally divided into three steps, namely feature extraction, probability prediction through a deep model, and global beat location estimation. The feature extraction usually uses frequency domain features. For example, Mel spectrogram and first-order difference thereof are usually used as input features. A deep network such as CRNN can be selected and used as a deep model to learn local features and time series features. The probability of a frame of audio data being a beat point can be calculated through the deep model.

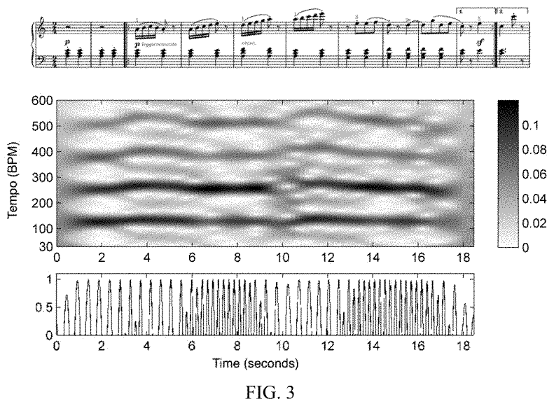

FIG. 3 illustrates a tempogram of a piece of music according to an exemplary embodiment of the present disclosure. The tempogram (as shown in the middle part of FIG. 3) can be calculated based on the probability obtained through calculation, and a location of a globally optimal beat can be calculated by using an algorithm similar to dynamic programming. In other implementations, the spectral flux can be detected as a basis for detecting downbeat information, and the spectral flux can show a transient change in the frequency domain. The downbeat can be calculated through the following formula:

$$H ( x ) = \frac{x + \vert x \vert}{2} , \\ {SF}_{norm} ( n ) = \frac{{\sum }_{k = - \frac{N}{2}}^{\frac{N}{2} - 1} H ( \vert X ( n , k ) \vert - \vert X ( n - 1 , k ) \vert )}{{\sum }_{k = - \frac{N}{2}}^{\frac{N}{2} - 1} \vert X ( n , k ) \vert} .$$

Herein, a function H represents half-wave rectification, and SFₙₒᵣₘ(n) represents the downbeat. X represents frequency domain information obtained through short-time Fourier transform of a signal, n represents an n^{th} frame, and N represents total number of frames, wherein k=−N/2.

According to exemplary embodiments of the present disclosure, in a step where the beat information of the audio signal is detected, the downbeat information of the audio signal may be detected. Herein, the downbeat information refers to the beat information of the stress of the audio signal.

In step S202, virtual surround sound for the audio signal is obtained by performing a convolution operation on a head-related transfer function and the audio signal based on the beat information of the audio signal.

According to exemplary embodiments of the present disclosure, in a step where the convolution operation is performed on the head-related transfer function and the audio signal based on the beat information of the audio signal, a head-related frequency impulse response of the audio signal may be first determined from the head-related transfer function based on the beat information of the audio signal, and the convolution operation is then performed on the head-related frequency impulse response of the audio signal and each frame of the audio signal.

According to exemplary embodiments of the present disclosure, in a step where the convolution operation is performed on the head-related transfer function and the audio signal based on the beat information of the audio signal, a first head-related frequency impulse response corresponding to at least one frame of the audio signal may be first determined from the head-related transfer function based on the beat information of the audio signal, a second head-related frequency impulse response corresponding to each frame of the audio signal except the at least one frame is determined from the head-related transfer function based on the beat information of the audio signal, the convolution operation is then performed on the first head-related frequency impulse response and the at least one frame of the audio signal, and the convolution operation is performed on the second head-related frequency impulse response and each frame of the audio signal except the at least one frame.

According to exemplary embodiments of the present disclosure, in a step where the convolution operation is performed on the head-related transfer function and the audio signal based on the beat information of the audio signal, the head-related frequency impulse response of the head-related transfer function in continuous directions may be first obtained, a rotation angle of each frame of the audio signal is determined based on the beat information of the audio signal, the head-related frequency impulse response corresponding to each frame of the audio signal is determined based on the rotation angle of each frame of the audio signal, and the convolution operation is then performed on corresponding head-related frequency impulse response and corresponding frame of the audio signal.

According to exemplary embodiments of the present disclosure, in a step where the rotation angle of each frame of the audio signal is determined based on the beat information of the audio signal, duration of each beat of the audio signal may be calculated first based on the beat information of the audio signal, time for one rotation of the audio signal may be calculated based on the duration of each beat of the audio signal, and the rotation angle of each frame of the audio signal is then calculated based on the one frame time of the audio signal and the time for one rotation of the audio signal. Herein, the time for one rotation of the audio signal is a predetermined integer multiple of the duration of each beat of the audio signal.

According to exemplary embodiments of the present disclosure, after a step where the beat information of the audio signal is detected, an initial azimuth angle of the audio signal may also be determined based on the downbeat information.

According to exemplary embodiments of the present disclosure, the virtual surround sound for the audio signal may also be processed through a predetermined audio effector.

After the beat information (e.g., beat per minute, BPM) of the music is determined in step S201, BPM or BPM change of the music is used, in step S202, as an input of a headphone virtualizer, to control the selection of the HRTF, so that the virtual surround sound is matched with the beat of the music. The virtual surround sound is achieved by performing a convolution operation on the head-related transfer function (HRTF) and each frame of the audio signal. HRTF is usually measured in anechoic and low-noise environment (e.g., in an anechoic chamber), and the binaural recording technology is utilized to measure the head-related frequency impulse responses (i.e., head-related impulse response, HRIR) of the left and right channels in different directions. A spatial localization of the sound is determined through left and right channel signals measured. HRTF is a result of transforming HRIR through Fourier transform from time domain to frequency domain.

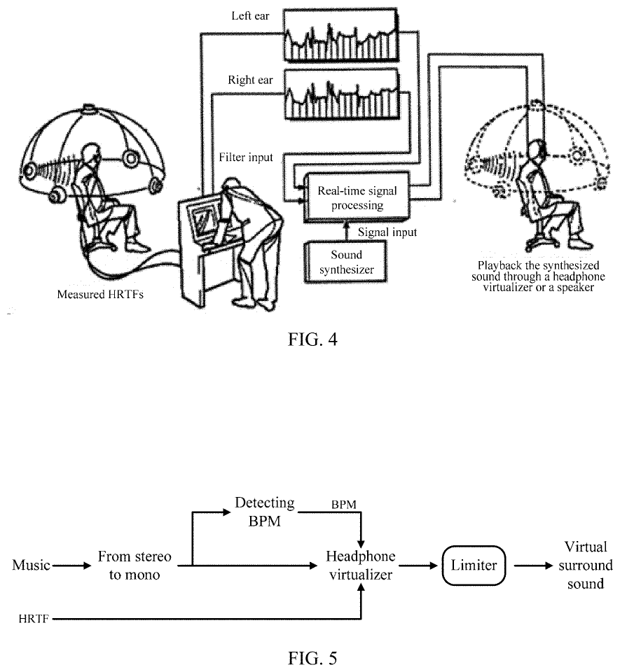

FIG. 4 illustrates a generation process of virtual surround sound according to an exemplary embodiment of the present disclosure. In FIG. 4, HRIRs of the HRTF in different directions are obtained through measurements, a convolution operation is performed on the audio signal to be played back and the HRIR in a certain direction, and the audio signal are finally played through headphones. As a result, the human ear may perceive that the sound is coming from the certain direction.

At present, many different HRIR databases have been produced. In the present disclosure, the virtual surround sound can be obtained by performing a convolution operation on the music signal using those existing HRIR databases.

In some implementations of the virtual surround sound, following steps E1 to E3 can be used to implement the virtual surround sound, so that the music is revolved around (clockwise or counterclockwise will be fine) the head at a certain speed.

In step E1, continuous HRIR is obtained. The HRIR measured is discrete, and composed of discrete signals in different directions. In some implementations, the continuous HRIR can be obtained through a linear interpolation.

In step E2, the rotation angle of each frame of the music is determined based on the BPM of the music obtained before, and the HRIR of each frame is determined based on the rotation angle of each frame of the music. In order to better match a revolved speed with a tempo of the music, the time for one rotation of the music is an integer multiple (e.g., 4 times) of the duration of each beat of the music.

The duration of each beat is calculated as: TimePerBeat=60/BPM,

The time for one rotation is calculated as: TimePerRound=a×60/BPM,

The one frame time of each frame is calculated as: TimePerFrame=SamplesPerFrame/SampleRate,

The rotation angle of each frame is calculated as: DegreePerFrame=360×TimePerFrame/TimePerRound=60×BPM×SamplesPerFrame/(SampleRate×a).

Herein, ‘a’ represents the multiple of the time for one rotation of the music relative to the duration of each beat of the music.

In step E3: the convolution operation is performed on each frame of the audio signal in time domain and corresponding HRIR.

Additionally, adjacent frames can be smoothed for a more natural-sounding sound. In addition, an initial azimuth angle (initial position) for the audio signal to revolve around the head can be determined based on detected downbeat time, so that the downbeat falls exactly in the right middle of the head, which can further enhance the listening experience of the audience.

Additionally, the music being processed is passed through some audio effectors (e.g., a limiter), so that the sound doesn't crackle. The audio effectors can also add EQ, compression and other effects to the music, change the timbre and dynamic feeling of the music, thereby giving the sound more variety, and making the music funnier.

FIG. 5 illustrates a block diagram of a system for generating virtual surround sound for music according to an exemplary embodiment of the present disclosure. As shown in FIG. 5, the music is first converted from stereo to mono, and then the BPM of the music is detected. The headphone virtualizer is adopted to control the selection of HRIR by using the BPM detected, and to perform convolution on each frame of the signal and corresponding HRIR. The output is finally passed through the limiter to obtain the virtual surround sound that revolves around the head in accordance with the rhythm of the music. In some examples, the headphone virtualizer may first determine the head-related frequency impulse response of the audio signal from the head-related transfer function based on the BPM of the audio signal, and then perform the convolution operation on the head-related frequency impulse response of the audio signal and each frame of the audio signal. In some other examples, the headphone virtualizer may first determine a first head-related frequency impulse response corresponding to at least one frame of the audio signal from the head-related transfer function based on the BPM of the audio signal, and determine a second head-related frequency impulse response corresponding to each frame of the audio signal except the at least one frame from the head-related transfer function based on the BPM of the audio signal. The headphone virtualizer may then perform the convolution operation on the first head-related frequency impulse response and the at least one frame of the audio signal, and perform the convolution operation on the second head-related frequency impulse response and each frame of the audio signal except the at least one frame. In some other examples, the headphone virtualizer may first obtain the head-related frequency impulse response of the head-related transfer function in continuous directions, determine a rotation angle of each frame of the audio signal based on the BPM of the audio signal, determine the head-related frequency impulse response corresponding to each frame of the audio signal based on the rotation angle of each frame, and then perform the convolution operation on corresponding head-related frequency impulse response and corresponding frame of the audio signal. Herein, when determining the rotation angle of each frame of the audio signal based on the BPM of the audio signal, the headphone virtualizer may first calculate duration of each beat of the audio signal based on the BPM of the audio signal, calculate time for one rotation of the audio signal based on the duration of each beat of the audio signal, and then calculate the rotation angle of each frame of the audio signal based on the one frame time of the audio signal and the time for one rotation of the audio signal. Herein, the time for one rotation of the audio signal is a predetermined integer multiple of the duration of each beat of the audio signal.

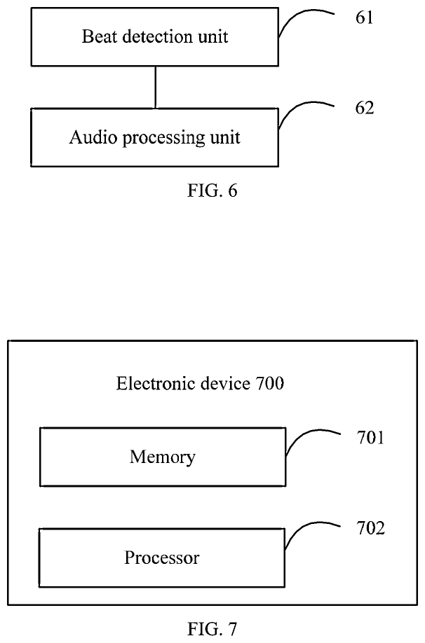

The method for processing the audio signal according to exemplary embodiments of the present disclosure has been described above with reference to FIGS. 1 to 5. An apparatus for processing an audio signal and units thereof according to exemplary embodiments of the present disclosure will be described in the following with reference to FIG. 6.

FIG. 6 illustrates a block diagram of an apparatus for processing an audio signal according to an exemplary embodiment of the present disclosure.

Referring to FIG. 6, the apparatus for processing an audio signal includes a beat detection unit 61 and an audio processing unit 62.

The beat detection unit 61 is configured to detect beat information of the audio signal.

According to exemplary embodiments of the present disclosure, the beat detection unit is configured to convert the audio signal into a mono audio signal; and detect the beat information of the mono audio signal as the beat information of the audio signal.

According to exemplary embodiments of the present disclosure, the beat detection unit is configured to detect spectral flux of the mono audio signal; and detect the beat information of the mono audio signal based on the spectral flux.

According to exemplary embodiments of the present disclosure, the beat detection unit is configured to extract a frequency domain feature of the mono audio signal; predict, for each frame of the audio signal, probability of a frame of the audio signal being a beat point based on the frequency domain feature; and determine the beat information of the audio signal based on the probability of a frame of the audio signal being a beat point.

According to exemplary embodiments of the present disclosure, the beat detection unit is configured to detect downbeat information of the audio signal.

The audio processing unit 62 is configured to obtain virtual surround sound for the audio signal by performing a convolution operation on a head-related transfer function and the audio signal based on the beat information of the audio signal.

According to exemplary embodiments of the present disclosure, the audio processing unit is configured to determine a head-related frequency impulse response of the audio signal from the head-related transfer function based on the beat information of the audio signal; and perform the convolution operation on the head-related frequency impulse response of the audio signal and each frame of the audio signal.

According to exemplary embodiments of the present disclosure, the audio processing unit is configured to determine a first head-related frequency impulse response corresponding to at least one frame of the audio signal from the head-related transfer function based on the beat information of the audio signal; determine a second head-related frequency impulse response corresponding to each frame of the audio signal except the at least one frame from the head-related transfer function based on the beat information of the audio signal; perform the convolution operation on the first head-related frequency impulse response and the at least one frame of the audio signal; and perform the convolution operation on the second head-related frequency impulse response and each frame of the audio signal except the at least one frame.

According to exemplary embodiments of the present disclosure, the audio processing unit is configured to obtain a head-related frequency impulse response of the head-related transfer function in continuous directions; determine a rotation angle of each frame of the audio signal based on the beat information of the audio signal; determine the head-related frequency impulse response corresponding to each frame of the audio signal based on the rotation angle of each frame of the audio signal; and perform the convolution operation on corresponding head-related frequency impulse response and corresponding frame of the audio signal.

According to exemplary embodiments of the present disclosure, the audio processing unit is configured to calculate duration of each beat of the audio signal based on the beat information of the audio signal; calculate time for one rotation of the audio signal based on the duration of each beat of the audio signal; and calculate the rotation angle of each frame of the audio signal based on the one frame time of the audio signal and the time for one rotation of the audio signal. Herein, the time for one rotation of the audio signal is a predetermined integer multiple of the duration of each beat of the audio signal.

According to exemplary embodiments of the present disclosure, the apparatus for processing the audio signal further includes an angle determination unit, which is configured to determine an initial azimuth angle of the audio signal based on the downbeat information.

According to exemplary embodiments of the present disclosure, the apparatus for processing the audio signal further includes an effect processing unit, which is configured to perform virtual surround sound processing on the audio signal through a predetermined audio effector.

Specific ways the units of the apparatus in above-mentioned embodiments perform operations have been described in detail in the method embodiments, and will not be described in detail here.

The apparatus for processing an audio signal according to exemplary embodiments of the present disclosure has been described above with reference to FIG. 6. Next, an electronic device according to exemplary embodiments of the present disclosure will be described with reference to FIG. 7.

FIG. 7 is a block diagram of an electronic device 700 according to an exemplary embodiment of the present disclosure.

Referring to FIG. 7, an electronic device 700 includes at least one memory 701 and at least one processor 702, and the at least one memory 701 has a set of computer-executable instructions stored therein. When the set of computer-executable instructions is executed by the at least one processor 702, the method for processing an audio signal according to exemplary embodiments of the present disclosure is implemented.

According to exemplary embodiments of the present disclosure, the electronic device 700 may be a PC computer, a tablet device, a personal digital assistant, a smart phone, or other devices capable of executing above-mentioned set of instructions. The electronic device 700 does not have to be a single electronic device, but can also be any collection of devices or circuits capable of executing above-mentioned instructions (or set of instructions) individually or jointly. The electronic device 700 may also be part of an integrated control system or a system manager, or may be configured as a portable electronic device that interfaces locally or remotely (e.g., via wireless transmission).

In electronic device 700, processor 702 may include a central processing unit (CPU), a graphics processing unit (GPU), a programmable logic device, a special purpose processor system, a microcontroller or a microprocessor. By way of example and not limitation, processors may also include analog processors, digital processors, microprocessors, multi-core processors, processor arrays, network processors, and the like.

The processor 702 may execute instructions or codes stored in memory 701, which may also store data. Instructions and data may also be sent and received over a network via a network interface device, which may employ any known transport protocols.

The memory 701 may be integrated with the processor 702. For example, the RAM or the flash memory is arranged within an integrated circuit microprocessor or the like. Furthermore, the memory 701 may include separate devices, such as an external disk drive, a storage array, or any other storage device that may be used by a database system. The memory 701 and the processor 702 may be operatively coupled, or may communicate with each other, via, for example, I/O ports, network connections, etc., to enable the processor 702 to read files stored in the memory.

Additionally, the electronic device 700 may also include a video display (such as a liquid crystal display) and a user interaction interface (such as a keyboard, a mouse, and a touch input device, etc.). All components of the electronic device 700 may be connected to each other via a bus and/or a network.

According to exemplary embodiments of the present disclosure, a computer-readable storage medium including instructions, for example, a memory 701 including instructions, is further provided, and the instructions can be executed by the processor 702 of the apparatus 700 to implement above method. Alternatively, the computer-readable storage medium may be ROM, random access memory (RAM), CD-ROM, magnetic tape, floppy disk, optical data storage device, and the like.

According to exemplary embodiments of the present disclosure, a computer program product is further provided, and the computer program product includes computer programs/instructions, which when executed by a processor, cause the method for processing an audio signal according to exemplary embodiments of the present disclosure to be implemented.

The method for processing an audio signal and the apparatus for processing an audio signal according to exemplary embodiments of the present disclosure have been described above with reference to FIGS. 1 to 7. However, it should be understood that the apparatus for processing an audio signal and the units thereof shown in FIG. 6 may be configured as software, hardware, firmware or any combination of the above items to perform specific functions. The electronic device shown in FIG. 7 is not limited to including the components shown above, but some components may be added or deleted as needed, and the above components may also be combined.

All embodiments of the present disclosure can be implemented independently or in combination with others, which are all regarded as falling in the protection scope of the present disclosure.

According to the method and the apparatus for processing an audio signal of the present disclosure, the virtual surround sound for the audio signal is obtained by detecting the beat information of the audio signal, and performing the convolution operation on the head-related transfer function and the audio signal based on the beat information of the audio signal. As a result, the dynamic feeling of the music can be enhanced, and the listening experience of the audience can be improved, so that the audience can feel sound immersive.

Additionally, according to the method and the apparatus for processing an audio signal of the present disclosure, a speed of a change in the azimuth angle of the virtual surround sound can be controlled by using the BPM of the music, which enables the music to dance around the head, and so that a change in a drum position and the music rhythm are in better fit.

Additionally, according to the method and the apparatus for processing an audio signal of the present disclosure, during a beat detection process, the downbeat of the music is detected, and the initial azimuth angle of the audio signal is determined, so that the downbeat happens exactly when the music revolves to the middle of the head.

Other embodiments of the present disclosure will readily occur to those skilled in the art upon consideration of the specification and practice of the invention disclosed herein. The present disclosure is intended to cover any variations, uses, or adaptations of the disclosure that follow the general principles of the present disclosure and include common knowledge or techniques in the technical field which is not disclosed by the present disclosure. The specification and examples are to be regarded as exemplary only, with the true scope and spirit of the present disclosure being indicated by appended claims.

It should be understood that the present disclosure is not limited to the precise structures described above and illustrated in the accompanying drawings, and that various modifications and changes may be made without departing from the scope thereof. The scope of the present disclosure is limited only by the appended claims.

What is claimed is:

1. A method for processing an audio signal, comprising:
detecting beat information of the audio signal; and
obtaining virtual surround sound for the audio signal by performing a convolution operation on a head-related transfer function and the audio signal based on the beat information of the audio signal.

2. The method for processing the audio signal according to claim 1, wherein said performing a convolution operation on a head-related transfer function and the audio signal based on the beat information of the audio signal comprises:
determining, based on the beat information of the audio signal, a head-related frequency impulse response of the audio signal from the head-related transfer function; and
performing the convolution operation on the head-related frequency impulse response of the audio signal and each frame of the audio signal.

3. The method for processing the audio signal according to claim 1, wherein said performing a convolution operation on a head-related transfer function and the audio signal based on the beat information of the audio signal comprises:
determining, based on the beat information of the audio signal, a first head-related frequency impulse response corresponding to at least one frame of the audio signal from the head-related transfer function;
determining, based on the beat information of the audio signal, a second head-related frequency impulse response corresponding to each frame of the audio signal except the at least one frame from the head-related transfer function;
performing the convolution operation on the first head-related frequency impulse response and the at least one frame of the audio signal; and
performing the convolution operation on the second head-related frequency impulse response and each frame of the audio signal except the at least one frame.

4. The method for processing the audio signal according to claim 1, wherein said performing a convolution operation on a head-related transfer function and the audio signal based on the beat information of the audio signal comprises:
obtaining a head-related frequency impulse response of the head-related transfer function in continuous directions;
determining a rotation angle of each frame of the audio signal based on the beat information of the audio signal;
determining the head-related frequency impulse response corresponding to each frame of the audio signal based on the rotation angle of each frame of the audio signal; and
performing the convolution operation on corresponding head-related frequency impulse response and corresponding frame of the audio signal.

5. The method for processing the audio signal according to claim 4, wherein said determining a rotation angle of each frame of the audio signal based on the beat information of the audio signal comprises:
calculating duration of each beat of the audio signal based on the beat information of the audio signal;
calculating time for one rotation of the audio signal based on the duration of each beat of the audio signal; and
calculating the rotation angle of each frame of the audio signal based on duration of each frame of the audio signal and the time for one rotation of the audio signal;
wherein the time for one rotation of the audio signal is a predetermined integer multiple of the duration of each beat of the audio signal.

6. The method for processing the audio signal according to claim 1, wherein said detecting beat information of the audio signal comprises:
detecting downbeat information of the audio signal.

7. The method for processing the audio signal according to claim 6, further comprising:
determining an initial azimuth angle of the audio signal based on the downbeat information.

8. The method for processing the audio signal according to claim 1, further comprising:
performing virtual surround sound processing on the audio signal through a predetermined audio effector.

9. The method for processing the audio signal according to claim 8, wherein the predetermined audio effector comprises a limiter.

10. An electronic device, comprising:
a processor; and
a memory for storing processor-executable instructions;
wherein the processor is configured to:
detect beat information of an audio signal; and
obtain virtual surround sound for the audio signal by performing a convolution operation on a head-related transfer function and the audio signal based on the beat information of the audio signal.

11. The electronic device according to claim 10, wherein the processor is configured to:
determine, based on the beat information of the audio signal, a head-related frequency impulse response of the audio signal from the head-related transfer function; and
perform the convolution operation on the head-related frequency impulse response of the audio signal and each frame of the audio signal.

12. The electronic device according to claim 10, wherein the processor is configured to:
determine, based on the beat information of the audio signal, a first head-related frequency impulse response corresponding to at least one frame of the audio signal from the head-related transfer function;
determine, based on the beat information of the audio signal, a second head-related frequency impulse response corresponding to each frame of the audio signal except the at least one frame from the head-related transfer function;
perform the convolution operation on the first head-related frequency impulse response and the at least one frame of the audio signal; and
perform the convolution operation on the second head-related frequency impulse response and each frame of the audio signal except the at least one frame.

13. The electronic device according to claim 10, wherein the processor is configured to:
obtain a head-related frequency impulse response of the head-related transfer function in continuous directions;
determine a rotation angle of each frame of the audio signal based on the beat information of the audio signal;
determine the head-related frequency impulse response corresponding to each frame of the audio signal based on the rotation angle of each frame of the audio signal; and
perform the convolution operation on corresponding head-related frequency impulse response and corresponding frame of the audio signal.

14. The electronic device according to claim 13, wherein the processor is configured to:
calculate duration of each beat of the audio signal based on the beat information of the audio signal;
calculate time for one rotation of the audio signal based on the duration of each beat of the audio signal; and
calculate the rotation angle of each frame of the audio signal based on duration of each frame of the audio signal and the time for one rotation of the audio signal;
wherein the time for one rotation of the audio signal is a predetermined integer multiple of the duration of each beat of the audio signal.

15. The electronic device according to claim 10, wherein the processor is configured to detect downbeat information of the audio signal.

16. The electronic device according to claim 15, wherein the processor is further configured to determine an initial azimuth angle of the audio signal based on the downbeat information.

17. The electronic device according to claim 10, wherein the processor is configured to:
convert the audio signal into a mono audio signal; and
detect the beat information of the mono audio signal as the beat information of the audio signal.

18. The electronic device according to claim 17, wherein the processor is configured to:
detect spectral flux of the mono audio signal; and
detect the beat information of the mono audio signal based on the spectral flux.

19. The electronic device according to claim 17, wherein the processor is configured to:
extract a frequency domain feature of the mono audio signal;
predict, for each frame of the audio signal, probability of a frame of the audio signal being a beat point based on the frequency domain feature; and
determine the beat information of the audio signal based on the probability.

20. A computer-readable storage medium having a computer program stored thereon, which when executed by a processor of an electronic device, cause the electronic device to:
detect beat information of an audio signal; and
obtain virtual surround sound for the audio signal by performing a convolution operation on a head-related transfer function and the audio signal based on the beat information of the audio signal.
